(19) United States
(12) Patent Application Publication
(10) Pub. No.: US 2016/0185901 A1
(43) Pub. Date: Jun. 30, 2016

(54) Polycarbonate Resin Pellets and Light Guide Plate Produced Using the Same

(71) Applicant: Samsung SDI Co., Ltd., Yongin-si (KR)

(72) Inventors: Woo Suk CHEI, Uiwang-si (KR); Jong Won LEE, Uiwang-si (KR); Jong Chan HUR, Uiwang-si (KR); Hyun Hye JANG, Uiwang-si (KR); Jun Ho CHI, Uiwang-si (KR)

(21) Appl. No.: 14/972,277

(22) Filed: Dec. 17, 2015

(30) Foreign Application Priority Data
Dec. 31, 2014 (KR) 10-2014-0195800

(51) Int. Cl. C08G 64/06; F21V 8/00

(52) U.S. Cl. CPC C08G 64/06; G02B 6/0065

(57) ABSTRACT

Polycarbonate resin pellets are disclosed herein. The polycarbonate resin pellets are formed of a polycarbonate resin composition having a melt-flow index (MI) of about 15 g/10 min to about 40 g/10 min as measured at about 250° C. under a load of about 1.2 kgf in accordance with ASTM D1238, wherein the polycarbonate resin pellets have a ratio of an average major diameter to an average minor diameter (average major diameter:average minor diameter) of about 1:0.5 to about 1:1 and a bulk density of about 600 g/cm³ to about 800 g/cm³. The polycarbonate resin pellets can reduce generation of powder chips caused by friction between pellets, thereby reducing appearance defects upon injection molding.

### CROSS-REFERENCE TO RELATED APPLICATION

This application claims priority under 35 USC Section 119 to and the benefit of Korean Patent Application 10-2014-0195800, filed Dec. 31, 2014, the entire disclosure of which is incorporated herein by reference.

### FIELD

The present invention relates to polycarbonate resin pellets and a light guide plate produced using the same.

### BACKGROUND

Since portable displays such as mobile phones have various sizes in recent years, light guide plates having larger sizes and thinner thicknesses than existing light guide plates having a size of about 2 inches to about 4 inches and a thickness of about 0.5 mm are required. To perform injection molding of larger-size and thinner light guide plates, it is necessary to secure fluidity and replication characteristics of a polycarbonate resin, since injection molding is performed at a higher temperature than typical molding temperatures. However, light guide plates injection-molded at high temperature can generally exhibit a yellow color (yellowing) in surface diffusion of light, as a main function thereof, and also can suffer from accelerated yellowing when used under high temperature and high humidity conditions for a long period of time.

To solve these problems, molding needs to be performed at an appropriate process temperature using a polycarbonate resin which exhibits excellent thermal stability and a good color after molding while exhibiting improved fluidity, as compared with typical polycarbonate resins. For example, to improve fluidity simultaneously with maintaining mechanical strength, Japanese Patent Laid-open Publication No. 2001-208917 discloses an aromatic polycarbonate having a tert-octyl phenoxy group as an end group, and Japanese Patent Laid-open Publication No. 2001-208918 discloses an aromatic polycarbonate having a long-chain alkyl phenoxy group as an end group. In addition, Japanese Patent Laid-open Publication No. 2001-215336 discloses a light guide plate manufactured using a resin composition, which exhibits improved fluidity and is composed of an aromatic polycarbonate and a copolyester carbonate having an aliphatic segment, and a method for preparing the resin composition.

However, typical high-fluidity polycarbonate resin pellets generate powder chips during preparation and transport thereof. Upon injection molding of an article using the polycarbonate resin pellets including such powder chips, the molded article can suffer from appearance defects due to white spots, gases and the like.

Therefore, there is a need for polycarbonate resin pellets for light guide plates, which can reduce generation of powder chips, and a light guide plate produced from the polycarbonate resin pellets and exhibiting reduced appearance defects due to white spots, gases and the like.

### SUMMARY OF THE INVENTION

Embodiments provide polycarbonate resin pellets which can reduce generation of powder chips caused by friction between pellets and appearance defects caused by white spots, gases and the like upon molding, and a light guide plate produced using the polycarbonate resin pellets.

The polycarbonate resin pellets are formed of a polycarbonate resin composition having a melt-flow index (MI) of about 15 g/10 min to about 40 g/10 min as measured at about 250° C. under a load of about 1.2 kgf in accordance with ASTM D1238, wherein the polycarbonate resin pellets have a ratio of an average major diameter to an average minor diameter (average major diameter:average minor diameter) of about 1:0.5 to about 1:1 and a bulk density of about 600 g/cm³ to about 800 g/cm³.

In exemplary embodiments, the polycarbonate resin pellets may be (elliptic) cylinder-shaped pellets having an average major diameter of about 2.0 mm to about 4.0 mm, an average minor diameter of about 1.5 mm to about 3.5 mm, and an average length of about 2.0 mm to about 4.0 mm.

In exemplary embodiments, the polycarbonate resin pellets may include less than about 50 ppm of powder chips having passed through an about 600 μm filter, as measured after the polycarbonate resin pellets are subjected to tumbling at about 18 rpm for about 8 hours.

In exemplary embodiments, the polycarbonate resin composition may include a polycarbonate resin which is a polymer of an aromatic dihydroxy compound and a diaryl carbonate, has a mole ratio of the aromatic dihydroxy compound to the diaryl carbonate of about 1:1.02 to about 1:1.35 and a weight average molecular weight of about 10,000 g/mol to about 18,000 g/mol, and includes about 5 mol % to about 30 mol % of a terminal hydroxyl group based on the total amount of terminal groups.

Other embodiments relate to a light guide plate. The light guide plate is injection-molded from the polycarbonate resin pellets as set forth above.

In exemplary embodiments, the light guide plate may include a front surface, a back surface facing the front surface, and a side surface connecting the front surface to the back surface, wherein the back surface may include an optical pattern formed thereon.

In exemplary embodiments, the side surface may include: a first side surface at which a light source is disposed; a second side surface facing the first side surface; a third side surface connecting the first side surface to the second side surface; and a fourth side surface facing the third side surface and connecting the first side surface to the second side surface.

In exemplary embodiments, the light guide plate may have an appearance defect rate of about 15% or less, as caused by white spots and gases upon injection molding.

### BRIEF DESCRIPTION OF DRAWINGS

FIG. 1 is a schematic perspective view of a light guide plate according to one embodiment of the present invention.

### DETAILED DESCRIPTION

Hereinafter, embodiments of the present invention will be described in detail in the following detailed description with reference to the accompanying drawings, in which some, but not all, embodiments are described. Indeed, this invention may be embodied in many different forms and should not be construed as limited to the embodiments set forth herein; rather, these embodiments are provided so that this disclosure will satisfy applicable legal requirements. It should be understood that the following embodiments are provided for complete disclosure and thorough understanding of the invention by those skilled in the art. In addition, unless otherwise stated, technical and scientific terms as used herein have a meaning generally understood by those skilled in the art. Descriptions of known functions and constructions which can unnecessarily obscure the subject matter of the invention will be omitted.

According to embodiments of the invention, polycarbonate resin pellets are formed of a polycarbonate resin composition having a melt-flow index (MI) of about 15 g/10 min to about 40 g/10 min, as measured at about 250° C. under a load of about 1.2 kgf in accordance with ASTM D1238, wherein the polycarbonate resin pellets have a ratio of an average major diameter to an average minor diameter (average major diameter:average minor diameter) of about 1:0.5 to about 1:1 and a bulk density of about 600 g/cm³ to about 800 g/cm³.

In some embodiments, the polycarbonate resin composition may have a melt-flow index (MI) of about 15, 16, 17, 18, 19, 20, 21, 22, 23, 24, 25, 26, 27, 28, 29, 30, 31, 32, 33, 34, 35, 36, 37, 38, 39, or 40 g/10 min. Further, according to some embodiments of the present invention, the polycarbonate resin composition may have a melt-flow index (MI) of from about any of the foregoing amounts to about any other of the foregoing amounts.

In some embodiments, the polycarbonate resin pellets may have a ratio of an average major diameter to an average minor diameter (average major diameter:average minor diameter) of about 1:0.5, 1:0.6, 1:0.7, 1:0.8, 1:0.9, or 1:1. Further, according to some embodiments of the present invention, the polycarbonate resin pellets may have a ratio of an average major diameter to an average minor diameter (average major diameter:average minor diameter) of from any of the foregoing ratios to about any other of the foregoing ratios.

In exemplary embodiments, the polycarbonate resin composition includes about 90% by weight (wt %) or more of a polycarbonate resin, for example, about 90, 91, 92, 93, 94, 95, 96, 97, 98, 99, or 100 wt % of a polycarbonate resin.

The polycarbonate resin can be a polymer of an aromatic dihydroxy compound and a diaryl carbonate, and may have a mole ratio of the aromatic dihydroxy compound to the diaryl carbonate (aromatic dihydroxy compound:diaryl carbonate) of about 1:1.02 to about 1:1.35, for example, about 1:1.02 to about 1:1.25 and a weight average molecular weight of about 10,000 g/mol to about 18,000 g/mol, for example, about 11,000 g/mol to about 17,000 g/mol as measured by gel permeation chromatography (GPC). Within this mole ratio range, the polycarbonate resin composition can exhibit excellent releasability and thermal stability upon injection molding, and a polycarbonate resin having a sufficient weight average molecular weight can be prepared. Within this range of the weight average molecular weight, the polycarbonate resin composition can exhibit excellent fluidity and mechanical properties.

In addition, the polycarbonate resin may include about 5 mol % to about 30 mol %, for example, about 10 mol % to about 28 mol %, of a terminal hydroxyl group based on 100 mol % of the total terminal groups, as measured by ¹H-NMR. In some embodiments, the polycarbonate resin may include terminal hydroxyl groups in an amount of about 5, 6, 7, 8, 9, 10, 11, 12, 13, 14, 15, 16, 17, 18, 19, 20, 21, 22, 23, 24, 25, 26, 27, 28, 29, or 30 mol %. Further, according to some embodiments of the present invention, the terminal hydroxyl groups may be present in an amount of from about any of the foregoing amounts to about any other of the foregoing amounts.

Within this range, the polycarbonate resin composition can exhibit excellent releasability and thermal stability upon injection molding thereof, and a polycarbonate resin having a sufficient weight average molecular weight can be prepared.

In exemplary embodiments, the polycarbonate resin may be prepared through melt polymerization (transesterification) of the aromatic dihydroxy compound and the diaryl carbonate.

The aromatic dihydroxy compound may be a typical aromatic dihydroxy compound used in preparation of an aromatic polycarbonate resin. For example, the aromatic dihydroxy compound may be a compound represented by Formula 1:

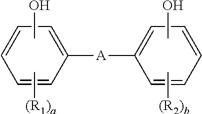

wherein A is a single bond, a substituted or unsubstituted C₁ to C₃₀ hydrocarbon group, —CO—, —S—, or —SO₂—; R₁ and R₂ are the same or different and are each independently a substituted or unsubstituted C₁ to C₃₀ alkyl group or a substituted or unsubstituted C₆ to C₃₀ aryl group; and a and b are the same or different and are each independently an integer of 0 to 4.

Unless otherwise stated, the term “hydrocarbon group” as used herein refers to linear, branched and/or cyclic saturated or unsaturated hydrocarbon groups. The “linear” hydrocarbon group may have a carbon number of 1 to 30. The “branched” hydrocarbon group may have a carbon number of 3 or more, for example 3 to 30, and the “cyclic” hydrocarbon group may have a carbon number of 4 or more, for example 4 to 30. In addition, unless otherwise stated, the term “substituted” as used herein means that a hydrogen atom is substituted with a substituent such as a halogen group, C₁ to C₃₀ alkyl group, C₁ to C₃₀ haloalkyl group, C₆ to C₃₀ aryl group, C₂ to C₃₀ heteroaryl group, C₁ to C₂₀ alkoxy group, and the like, and combinations thereof. Also as used herein, unless otherwise stated, the term “hetero” refers to one or more of an oxygen atom (O), a nitrogen atom (N), a sulfur atom (S), a phosphorous atom (P), and the like and combinations thereof.

In exemplary embodiments, A is a single bond, a substituted or unsubstituted C₁ to C₃₀ alkylene group, a substituted or unsubstituted C₂ to C₅ alkenylene group, a substituted or unsubstituted C₂ to C₅ alkylidene group, a substituted or unsubstituted C₅ to C₆ cycloalkylene group, a substituted or unsubstituted C₅ to C₁₀ cycloalkylidene group, a substituted or unsubstituted C₆ to C₃₀ arylene group, a substituted or unsubstituted C₁ to C₂₀ alkoxylene group, a halogen acid ester group, a carbonic acid ester group, —CO—, —S—, or —SO₂—; and R₁ and R₂ are the same or different and are each independently a substituted or unsubstituted C₁ to C₃₀ alkyl group, for example, a C₁ to C₁₀ alkyl group, or a substituted or unsubstituted C₆ to C₃₀ aryl group, for example, C₆ to C₁₀ aryl group.

Examples of the aromatic dihydroxy compound may include 2,2-bis(4-hydroxyphenyl)propane, 4,4′-biphenol, 2,4-bis(4-hydroxyphenyl)-2-methylbutane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, 2,2-bis(3-chloro-4-hydroxyphenyl)propane, 2,2-bis(3,5-dichloro-4-hydroxyphenyl)propane, and the like, and combinations thereof, without being limited thereto. In exemplary embodiments, the aromatic dihydroxy compound may include 2,2-bis(4-hydroxyphenyl)propane (“bisphenol A”).

The diaryl carbonate may be a typical diaryl carbonate used to prepare a polycarbonate resin. For example, the diaryl carbonate may be a compound represented by Formula 2:

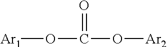

wherein Ar₁ and Ar₂ are the same or different and are each independently a substituted or unsubstituted C₆ to C₂₀ aryl group, for example C₆ to C₁₀ aryl group.

Examples of the diaryl carbonate may include diphenyl carbonate, ditolyl carbonate, bis(chlorophenyl)carbonate, m-cresyl carbonate, dinaphthyl carbonate, bis(diphenyl)carbonate, and the like, and combinations thereof, without being limited thereto. In exemplary embodiments, the diaryl carbonate may include diphenyl carbonate.

In exemplary embodiments, melt polymerization may be performed in the presence of a catalyst. The catalyst may be a typical catalyst used for melt polymerization of an aromatic polycarbonate resin. For example, the catalyst may be an alkali metal catalyst, an alkaline earth metal catalyst, and the like, and combinations thereof. Examples of the alkali metal catalyst may include LiOH, NaOH, and/or KOH, without being limited thereto. These catalysts may be used alone or in combination thereof.

In exemplary embodiments, the catalyst may be present in an amount of about 60 ppb to about 300 ppb (in terms of mole), for example, about 80 ppb to about 150 ppb based on the total amount of the aromatic dihydroxy compound. Within this range, the polycarbonate resin can be prevented from yellowing due to residual catalyst.

Melt polymerization may be performed at a temperature of about 250° C. to about 290° C., for example, about 260° C. to about 280° C. at a pressure of about 0.1 torr to about 100 torr, for example, about 0.3 torr to about 50 torr, for example, for about 1 hour to about 10 hours. Within this range, an aromatic polycarbonate resin having a weight average molecular weight in the range as set forth above and including the terminal hydroxyl group in an amount in the range as set forth above can be prepared.

In exemplary embodiments, when polymerization is performed, typical additives, such as antioxidants, heat stabilizers, release agents, and the like, and combinations thereof, may be further added. The additive may be present in an amount of about 0.01 to parts by weight to about 1 part by weight, for example, about 0.01 parts by weight to about 0.1 parts by weight based on about 100 parts by weight of the reactants. It is desirable that the amount of the additive be used as small as possible in terms of discoloration resistance and the like.

The aromatic polycarbonate resin polymerized from the aromatic dihydroxy compound and the diaryl carbonate in the above mole ratio by the preparation method as set forth above may include a hydroxyl group (—OH) of the aromatic dihydroxy compound and/or an aryloxy group, such as a phenoxy group of the diaryl carbonate, as terminal groups.

In exemplary embodiments, the polycarbonate resin composition may have a melt-flow index (MI) of about 15 g/10 min to about 40 g/10 min, for example, about 20 g/10 min to about 30 g/10 min, as measured at about 250° C. under a load of about 1.2 kgf in accordance with ASTM D1238. Within this range, the polycarbonate resin composition can exhibit excellent injection moldability, and thus can allow a larger and thinner light guide plate to be manufactured.

The polycarbonate resin pellets according to embodiments of the invention may be produced from the polycarbonate resin composition through, for example, a typical extrusion method such that an angle of an extruder cutter is adjusted to about 10° to about 30° so as to allow the resin composition exiting an extruder nozzle to be cut perpendicular to the longitudinal direction of an extruded strand.

A ratio of an average major diameter to an average minor diameter (average major diameter:average minor diameter) of the polycarbonate resin pellets may range from about 1:0.5 to about 1:1, for example, from about 1:0.6 to about 1:0.9. When the pellets are produced from a high-fluidity polycarbonate resin composition having a melt-flow index of about 10 g/10 min using a typical cutting method, the ratio of the average major diameter to the average minor diameter of the pellets is generally less than about 1:0.5. If the ratio of the average major diameter to the average minor diameter of the pellets is less than about 1:0.5, there are concerns that the amount of powder chips generated during production and transport of the pellets can be increased, and that a molded article can suffer from appearance defects upon injection molding due to the generated powder chips.

In exemplary embodiments, the polycarbonate resin pellets may be (elliptic) cylinder-shaped pellets having an average major diameter of about 2.0 mm to about 4.0 mm, for example, about 2.5 mm to about 3.5 mm, an average minor diameter of about 1.5 mm to about 3.5 mm, for example, about 2.0 mm to about 3.0 mm, and an average length of about 2.0 mm to about 4.0 mm, for example, about 2.0 mm to about 3.0 mm. Within this range, the polycarbonate resin pellets can suppress generation of powder chips during production and transport thereof, and can reduce appearance defects of a molded article upon injection molding.

In addition, the polycarbonate resin pellets may have a bulk density of about 600 g/cm³ to about 800 g/cm³, for example, about 610 g/cm³ to about 700 g/cm³. Within this range, the polycarbonate resin pellets can suppress generation of powder chips during production and transport thereof, and can reduce appearance defects of a molded article upon injection molding.

In exemplary embodiments, the polycarbonate resin pellets may include less than about 50 ppm, for example, about 10 ppm to about 40 ppm of powder chips having passed through an about 600 μm filter based on the total weight of the polycarbonate resin pellets, as measured after the polycarbonate resin pellets are subjected to tumbling at about 18 rpm for about 8 hours. Within this range, the polycarbonate resin pellets can reduce appearance defects of a molded article due to white spots and gases upon injection molding.

According to embodiments of the present invention, a light guide plate is injection-molded from the polycarbonate resin pellets as set forth above.

In exemplary embodiments, injection molding may be performed by preparing a molten resin by heating the polycarbonate resin pellets to an injection molding temperature (cylinder temperature) of about 320° C. to about 360° C., for example, about 330° C. to about 350° C., followed by injecting the molten resin into a cavity of a mold, which has a mold temperature of about 50° C. to about 110° C., for example, about 70° C. to about 100° C., at an injection rate of about 300 mm/sec to about 800 mm/sec, for example, about 500 mm/sec to about 700 mm/sec. Within this range, the light guide plate can exhibit excellent discoloration resistance and brightness quality (brightness uniformity) as well as low color deviation.

Injection molding may be performed using, for example, a general steel mold, a heat insulating mold including a low thermal conductivity material (ceramics, resins such as polyimides, and the like) as a portion of the mold, a method of selectively rapidly heating and cooling a surface of a mold, or the like. For example, injection molding may be performed using a heat insulating mold including zirconia. When the heat insulating mold is used, formation of a solidification layer due to quick cooling of the molten resin in the cavity of the mold can be avoided. In addition, since filling the cavity with the molten polycarbonate resin pellets (molten resin) is facilitated as compared with the general steel molds even though the mold has an extremely thin thickness, the heat insulating mold can be more suitable for manufacturing a light guide plate having excellent replication of fine uneven patterns.

The light guide plate according to the embodiments of the invention may have a shape of a typical light guide plate, for example, a shape such as wedge shapes, flat plate shapes, and the like. In exemplary embodiments, the light guide plate may include at least one uneven pattern (a pattern such as prism shapes, cylinder shapes, and the like) formed on an inclined surface or a flat surface thereof. The uneven pattern may be imparted by transferring an uneven portion partially formed on a surface of the mold.

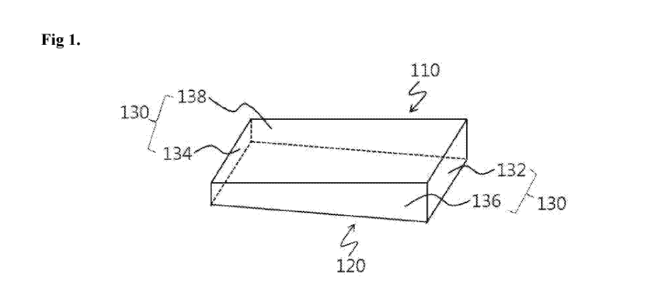

FIG. 1 is a schematic perspective view of a light guide plate according to one embodiment of the present invention. Referring to FIG. 1, the light guide plate according to this embodiment includes a front surface 110, a back surface 120 facing the front surface 110, and a side surface 130 connecting the front surface 110 to the back surface 120, wherein the back surface 120 may include an optical pattern (not shown) formed thereon.

The front surface 110 may face a panel (LCD panel or the like) of a display and allow a screen of the display to be displayed by emitting light from a side light source toward the panel.

The back surface 120 faces the front surface 110 and can improve optical efficiency by reflecting some of light from a side light source toward the front surface 110. When formed on the back surface 120, the optical pattern can allow light of the light source to be emitted toward the panel through the front surface 110 through total reflection, thereby improving optical efficiency of the light guide plate.

The optical pattern may be randomly formed without limitation as to density and separation distance as well as a shape, such as an engraved shape, an embossed shape, and the like, and mixtures thereof, so long as the optical pattern can reflect light from the side light source. In addition, the optical pattern may have a shape such as cones and/or prism bars, without being limited thereto. The optical pattern may have a height of about 6 μm to about 30 μm and a width or diameter of about 10 μm to about 35 μm, without being limited thereto.

The side surface 130 may include a first side surface 132 at which the light source is disposed, a second side surface 134 facing the first side surface 132, a third side surface 136 connecting the first side surface 132 to the second side surface 134, and a fourth side surface 138 facing the third side surface 136 and connecting the first side surface 132 to the second side surface 134.

The light guide plate may have an inclined surface (back surface) such that the first side surface has a greater height than the second side surface, as shown in FIG. 1, and may also have a flat plate shape. For example, the light guide plate may have an inclined surface-containing shape.

In addition, the light guide plate may have an average thickness of about 0.3 mm to about 0.7 mm, for example, about 0.35 mm to about 0.50 mm. Within this range, a thin portable display can be manufactured.

In exemplary embodiments, the polycarbonate resin pellets reducing generation of powder chips are applied to (used to manufacture) the light guide plate, whereby the light guide plate may have an appearance defect rate of about 15% or less, for example, about 5% to about 10%, as caused by white spots and gases upon injection molding. Herein, appearance defect rate is determined by appearance evaluation by observing the light guide plate with the naked eye under an LED fluorescent lamp. In this appearance evaluation, a foreign substance having a shining white color is determined as a white spot and a wave pattern or stain observed on the surface of the light guide plate is determined as a defect caused by gases. In addition, the appearance defect rate is calculated by counting the to number of injection-molded light guide plates having a defect after producing about 100 light guide plates by injection molding.

Next, the present invention will be described in more detail with reference to the following examples. It should be understood that these examples are provided for illustration only and are not to be construed in any way as limiting the present invention.

### EXAMPLES

### Preparative Example 1

### Production of Polycarbonate Resin Pellets

A bisphenol A polycarbonate resin having a melt-flow index (MI) of 25 g/10 min (ASTM D1238, 250° C., 1.2 kgf) is introduced into a twin screw extruder having a diameter of 45 mm, and L/D=44, followed by melting and extruding the resin at a screw rotation speed of 250 rpm and at a temperature as listed in Table 1. Next, an angle of an extruder cutter is adjusted to 10° to 30° such that a resin composition strand coming out from a die hole of the extruder could be cut perpendicular to the longitudinal direction of the strand, thereby producing polycarbonate resin pellets having an average major diameter of 4.0 mm and an average minor diameter of 2.4 mm.

### Preparative Example 2

### Production of Polycarbonate Resin Pellets

A bisphenol A polycarbonate resin having a melt-flow index (MI) of 25 g/10 min (ASTM D1238, 250° C., 1.2 kgf) is introduced into a twin screw extruder having a diameter of 45 mm, and L/D=44, followed by melting and extruding the resin at a screw rotation speed of 250 rpm at a temperature as listed in Table 1. Next, an angle of an extruder cutter is adjusted to 10° to 30° such that a resin composition strand exiting a die hole of the extruder could be cut perpendicular to the longitudinal direction of the strand, thereby producing polycarbonate resin pellets having an average major diameter of 3.4 mm and an average minor diameter of 2.7 mm.

### Preparative Example 3

### Production of Polycarbonate Resin Pellets

A bisphenol A polycarbonate resin having a melt-flow index (MI) of 25 g/10 min to (ASTM D1238, 250° C., 1.2 kgf) is introduced into a twin screw extruder having a diameter of 45 mm, and L/D=44, followed by melting and extruding the resin at a screw rotation speed of 250 rpm at a temperature as listed in Table 1. Next, an angle of an extruder cutter is adjusted to 10° to 30° such that a resin composition strand exiting a die hole of the extruder could be cut perpendicular to the longitudinal direction of the strand, thereby producing polycarbonate resin pellets having an average major diameter of 2.8 mm and an average minor diameter of 2.3 mm.

### Preparative Example 4

### Production of Polycarbonate Resin Pellets

A bisphenol A polycarbonate resin having a melt-flow index (MI) of 25 g/10 min (ASTM D1238, 250° C., 1.2 kgf) is introduced into a twin screw extruder having a diameter of 45 mm, and L/D=44, followed by melting and extruding the resin at a screw rotation speed of 250 rpm at a temperature as listed in Table 1. Next, an angle of an extruder cutter is adjusted to 10° to 30° such that a resin composition strand exiting a die hole of the extruder could be cut perpendicular to the longitudinal direction of the strand, thereby producing polycarbonate resin pellets having an average major diameter of 4.2 mm and an average minor diameter of 1.8 mm.

### Preparative Example 5

### Production of Polycarbonate Resin Pellets

A bisphenol A polycarbonate resin having a melt-flow index (MI) of 25 g/10 min (ASTM D1238, 250° C., 1.2 kgf) is introduced into a twin screw extruder having a diameter of 45 mm, and L/D=44, followed by melting and extruding the resin at a screw rotation speed of 250 rpm at a temperature as listed in Table 1. Next, an angle of an extruder cutter is adjusted to 10° to 30° such that a resin composition strand exiting a die hole of the extruder could be cut perpendicular to the longitudinal direction of the strand, thereby producing polycarbonate resin pellets having an average major diameter of 2.8 mm and an average minor diameter of 1.3 mm.

### Preparative Example 6

### Production of Polycarbonate Resin Pellets

A bisphenol A polycarbonate resin having a melt-flow index (MI) of 25 g/10 min to (ASTM D1238, 250° C., 1.2 kgf) is introduced into a twin screw extruder having a diameter of 45 mm, and L/D=44, followed by melting and extruding the resin at a screw rotation speed of 250 rpm at a temperature as listed in Table 1. Next, an angle of an extruder cutter is adjusted to 10° to 30° such that a resin composition strand exiting a die hole of the extruder could be cut perpendicular to the longitudinal direction of the strand, thereby producing polycarbonate resin pellets having an average major diameter of 4.1 mm and an average minor diameter of 2.9 mm.

Property Evaluation

(1) Average major diameter, average minor diameter and average length of pellets (unit: mm): 30 pellets out of the produced polycarbonate resin pellets are randomly selected, followed by measuring a major diameter, a minor diameter and a length of each of the pellets and calculating an average value thereof. Results are shown in Table 1.

(2) Bulk density (unit: g/cm³): A weight of the polycarbonate resin pellets filling a 100 cm³ graduated cylinder is measured, followed by calculating a bulk density thereof.

(3) Amount of powder chips (unit: ppm): 10 kg of the produced polycarbonate resin pellets is introduced into a tumbler, followed by tumbling at 18 rpm for 8 hours. Next, an amount of powder chips passing through a 600 μm filter is measured.

TABLE 1

| | Preparative | Preparative | Preparative | Preparative | Preparative | Preparative |
|---|---|---|---|---|---|---|
| | Example 1 | Example 2 | Example 3 | Example 4 | Example 5 | Example 6 |
| Average major | 4.0 | 3.4 | 2.8 | 4.2 | 2.8 | 4.1 |
| diameter (mm) | | | | | | |
| Average minor | 2.4 | 2.7 | 2.3 | 1.8 | 1.3 | 2.9 |
| diameter (mm) | | | | | | |
| Average | 2.9 | 2.9 | 3.2 | 2.7 | 2.3 | 2.7 |
| length (mm) | | | | | | |
| Average major | 1:0.60 | 1:0.72 | 1:0.82 | 1:0.45 | 1:0.47 | 1:0.70 |
| diameter:Average | | | | | | |
| minor diameter | | | | | | |
| Bulk density | 675 | 699 | 707 | 590 | 680 | 590 |
| (g/cm³) | | | | | | |
| Amount of | 40 | 22 | 20 | 72 | 50 | 55 |
| generated | | | | | | |
| powder chips | | | | | | |
| (ppm) | | | | | | |
| Extruder | 230 | 230 | 230 | 260 | 250 | 250 |
| temperature | | | | | | |
| (° C.) | | | | | | |

From the results, it can be seen that the polycarbonate resin pellets of Preparative Examples 4 to 6 having a ratio of the average major diameter to the average minor diameter (average major diameter:average minor diameter) of less than 1:0.5 and/or a bulk density of less than 600 g/cm³ include powder chips in an amount of 50 ppm or more, which is higher than the amount of powder chips generated in the polycarbonate resin pellets of Preparative Examples 1 to 3 having a ratio of the average major diameter to the average minor diameter (average major diameter:average minor diameter) of 1:0.5 or more and a bulk density of more than 600 g/cm³, which correspond to the ranges according to the present invention.

### Examples 1 to 3 and Comparative Examples 1 to 3

### Manufacture and Evaluation of Light Guide Plate

A light guide plate is manufactured through injection molding of the polycarbonate resin pellets produced in each of Preparative Examples 1 to 6 under conditions of an injection temperature of 340° C., a mold temperature of 70° C., an injection rate of 500 mm/sec and a molding cycle time of 13 seconds using a 130-ton injection molding machine (Toyo Machinery and Metal Co., Ltd.) including a thin mold having a front side diagonal length of 8 inches and an average thickness of 0.5 mm. Appearance defects of the manufactured light guide plate are evaluated by the following method. Results are shown in Table 2.

Property Evaluation

Appearance defect rate (unit: %): When the injection-molded light guide plate is observed with the naked eye under an LED fluorescent lamp, a foreign substance having a shining white color is determined as a white spot, and a wave pattern or stain observed on a surface of the light guide plate is determined as a defect caused by gases. An appearance defect rate is calculated by counting the number of light guide plates having such defects among 100 light guide plates produced by injection molding.

TABLE 2

| | | | | Comparative | Comparative | Comparative |
|---|---|---|---|---|---|---|
| | Example 1 | Example 2 | Example 3 | Example 1 | Example 2 | Example 3 |
| Pellets | Preparative | Preparative | Preparative | Preparative | Preparative | Preparative |
| | Example 1 | Example 2 | Example 3 | Example 4 | Example 5 | Example 6 |
| Amount of powder | 40 | 22 | 20 | 72 | 50 | 55 |
| chips (ppm) | | | | | | |
| Appearance | 15 | 15 | 14 | 40 | 30 | 35 |
| defect rate (%) | | | | | | |

From the results, it can be seen that the light guide plates of Examples 1 to 3 using the pellets including a low amount of powder chips have reduced appearance defects as compared with the light guide plates of Comparative Examples 1 to 3 using the pellets including 50 ppm or more of powder chips.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention is defined by the appended claims and equivalents thereof.

What is claimed is:

1. Polycarbonate resin pellets formed of a polycarbonate resin composition having a melt-flow index (MI) of about 15 g/10 min to about 40 g/10 min as measured at about 250° C. under a load of about 1.2 kgf in accordance with ASTM D1238,
wherein the polycarbonate resin pellets have a ratio of an average major diameter to an average minor diameter (average major diameter:average minor diameter) of about 1:0.5 to about 1:1 and a bulk density of about 600 g/cm³ to about 800 g/cm³.

2. The polycarbonate resin pellets according to claim 1, wherein the polycarbonate resin pellets are (elliptic) cylinder-shaped pellets having an average major diameter of about 2.0 mm to about 4.0 mm, an average minor diameter of about 1.5 mm to about 3.5 mm, and an average length of about 2.0 mm to about 4.0 mm.

3. The polycarbonate resin pellets according to claim 1, comprising: less than about 50 ppm of powder chips having passed through an about 600 μm filter, as measured after the polycarbonate resin pellets are subjected to tumbling at about 18 rpm for about 8 hours.

4. The polycarbonate resin pellets according to claim 1, wherein the polycarbonate resin composition comprises a polycarbonate resin which is a polymer of an aromatic dihydroxy compound and a diaryl carbonate, has a mole ratio of the aromatic dihydroxy compound to the diaryl carbonate of about 1:1.02 to about 1:1.35 and a weight average molecular weight of about 10,000 g/mol to about 18,000 g/mol, and comprises about 5 mol % to about 30 mol % of terminal hydroxyl groups based on a total amount of terminal groups.

5. A light guide plate injection-molded from the polycarbonate resin pellets according to claim 1.

6. The light guide plate according to claim 5, comprising: a front surface; a back surface facing the front surface; and a side surface connecting the front surface to the back surface, wherein the back surface comprises an optical pattern formed thereon.

7. The light guide plate according to claim 5, wherein the side surface comprises: a first side surface at which a light source is disposed; a second side surface facing the first side surface; a third side surface connecting the first side surface to the second side surface; and a fourth side surface facing the third side surface and connecting the first side surface to the second side surface.

8. The light guide plate according to claim 5, wherein the light guide plate has an appearance defect rate of about 15% or less, as caused by white spots and gases upon injection molding.
